(19) United States
(12) Patent Application Publication
(10) Pub. No.: US 2025/0058815 A1
(43) Pub. Date: Feb. 20, 2025

(54) STROLLER SUSPENSION SYSTEM

(71) Applicant: Monahan Products, LLC, Rockland, MA (US)

(72) Inventors: Michael Workman, Scituate, MA (US); Matthew Luis Rivera, Roswell, GA (US); Richard M. Bastien, Cumberland, RI (US); Meghan Kathleen O'Donovan, Boston, MA (US)

(21) Appl. No.: 18/806,249

(22) Filed: Aug. 15, 2024

Related U.S. Application Data
(60) Provisional application No. 63/533,475, filed on Aug. 18, 2023.

(51) Int. Cl. B62B 9/18

(52) U.S. Cl. CPC B62B 9/18

(57) ABSTRACT

According to at least one aspect of the present disclosure, a suspension system for a stroller is provided, the suspension system comprising a shroud having a lower section, an upper section, and a sliding section slidably coupled between the lower section and upper section, the sliding section configured to provide a degree of travel to the lower section and upper section equal to or less than a length of the sliding section; a first spring located at least partially within the lower section; a second spring located at least partially within the upper section; and a washer located between the first spring and the second spring and within the sliding section.

### CROSS-REFERENCE TO RELATED APPLICATIONS

This application claims priority under 35 U.S.C. § 119 (e) to U.S. Provisional Application No. 63/533,475 titled “STROLLER SUSPENSION SYSTEM” and filed on Aug. 18, 2023, which is incorporated by reference in its entirety for all purposes.

### BACKGROUND

At least one example in accordance with the present disclosure relates generally to suspension systems for strollers. Suspension systems may be devices designed to increase the smoothness of a ride in a vehicle, or decrease the impact felt by passengers in a vehicle of bumps and other irregularities along the way.

### SUMMARY

According to at least one aspect of the present disclosure, a suspension system for a stroller is provided, the suspension system comprising a shroud having a lower section, an upper section, and a middle section slidably coupled between the lower section and upper section, the middle section configured to provide a degree of travel to the lower section and upper section equal to or less than a length of the middle section; a first spring located at least partially within the lower section; a second spring located at least partially within the upper section; and a washer located between the first spring and the second spring and within the middle section.

In some examples, the suspension system further comprises a spring retention element coupled to the upper section and configured to mate with the second spring, the spring retention element having a smaller radius than the middle section. In some examples, the suspension system further comprises a cap section coupled to the spring retention element and the upper section, the cap section including a mating feature configured to mate with a locking mechanism on the stroller. In some examples, the washer is coupled to an interior surface of the middle section. In some examples, one of the upper section and the lower section has a larger radius than the middle section, and one of the upper section and lower section has a smaller radius than the middle section. In some examples, one of the first spring and second spring has a higher spring coefficient than another of the first spring and second spring. In some examples, the lower frame section includes one or more prongs; the sliding frame section includes one or more channels; and the one or more prongs are configured to slidably travel within the one or more channels. In some examples, the one or more channels are oriented along a direction parallel to a longitudinal axis of the middle section. In some examples, the middle section includes one or more prongs;

the upper frame section includes one or more channels; and the one or more prongs are configured to slidably travel within the one or more channels. In some examples, the washer includes a first protrusion on a first face of the washer and a second protrusion on a second face of the washer, the first and second faces being on opposite sides of the washer; and the first protrusion having a radius less than an inner radius of the first spring, and the second protrusion having a radius less than an inner radius of the second spring.

According to at least one aspect of the present disclosure, a stroller is presented, the stroller comprising a frame having at least an upper portion and a lower portion; and a suspension system coupled between the upper portion of the frame and the lower portion of the frame, the suspension system including: a lower section coupled to the lower portion of the frame; an upper section coupled to the upper portion of the frame; a sliding portion coupled between the lower section and the upper section, the middle section configured to provide a degree of travel to the lower section and upper section equal to or less than a length of the middle section; a first spring at least partially within the lower section; a second spring at least partially within the upper section; and a washer between the first spring and the second spring and within the middle section.

In some examples, the suspension system further comprises: a spring retention element coupled to the upper section and configured to mate with the second spring, the spring retention element having a smaller radius than the middle section. In some examples, the suspension system further comprises a first mating feature coupled to the frame; and wherein the suspension system further includes a second mating feature coupled to the upper section and configured to mate with the first mating feature. In some examples, the stroller is configurable into a stowable position from a use position and a use position from a stowable position. In some examples, the suspension system further comprises: one or more prongs coupled to the lower frame section; one or more channels incorporated into the sliding frame section; and the one or more prongs are configured to slidably travel within the one or more channels. In some examples, the suspension system further comprises: one or more prongs coupled to the sliding frame section; one or more channels incorporated into the upper frame section; and the one or more prongs are configured to slidably travel within the one or more channels. In some examples, the washer further comprises: a first protrusion on a first face of the washer and a second protrusion on a second face of the washer, the first and second faces being on opposite sides of the washer; and the first protrusion having a radius less than an inner radius of the first spring, and the second protrusion having a radius less than an inner radius of the second spring. In some examples, one spring of the first spring and second spring has a higher spring coefficient than another spring of the first spring and second spring.

According to at least one aspect of the present disclosure, a suspension system for a stroller is provided, the suspension system comprising: an upper section; a lower section; and a middle section, the middle section being configured to provide a range of travel between the upper section and lower section in a direction of a longitudinal axis of the middle section, the range of travel being less than or equal to a length of the middle section along the longitudinal axis, the middle section, upper section, and lower section being biased by a biasing mechanism into an equilibrium position when the stroller is at rest.

In some examples, the biasing mechanism includes: a first spring having a first spring coefficient located at least partially in the lower section; a second spring having a second spring coefficient different than the first spring coefficient and located at least partially in the upper section; and a washer located within the middle section and having a first protrusion on a first face of the washer and a second protrusion on a second face of the washer, the first and second faces being on opposite sides of the washer, the first protrusion having a radius less than an inner radius of the first spring, and the second protrusion having a radius less than an inner radius of the second spring.

### BRIEF DESCRIPTION OF THE DRAWINGS

Various aspects of at least one embodiment are discussed below with reference to the accompanying figures, which are not intended to be drawn to scale. The figures are included to provide an illustration and a further understanding of the various aspects and embodiments, and are incorporated in and constitute a part of this specification, but are not intended as a definition of the limits of any particular embodiment. The drawings, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure. In the figures:

FIG. 1A illustrates a stroller according to an example;

FIG. 1B illustrates a stroller according to an example;

FIG. 2A illustrates a suspension system according to an example;

FIG. 2B illustrates a suspension system according to an example;

FIG. 3A illustrates a suspension system according to an example;

FIG. 3B illustrates a suspension system according to an example;

FIG. 4A illustrates a suspension system according to an example;

FIG. 4B illustrates a suspension system according to an example;

FIG. 4C illustrates a suspension system according to an example;

FIG. 5 illustrates a suspension system according to an example; and

FIG. 6 illustrates springs and a washer according to an example.

### DETAILED DESCRIPTION

Strollers may be used to transport infants and children from place to place. Strollers may be used to traverse any number of different surfaces, both on-road and off-road. As a result, in some cases strollers may be taken along routes that have irregularities. While traversing irregularities, the passenger may be disturbed by vibrations, bumps, and so forth. Suspension systems described herein may reduce the impact of irregularities, such as bumps and potholes, on stroller passengers.

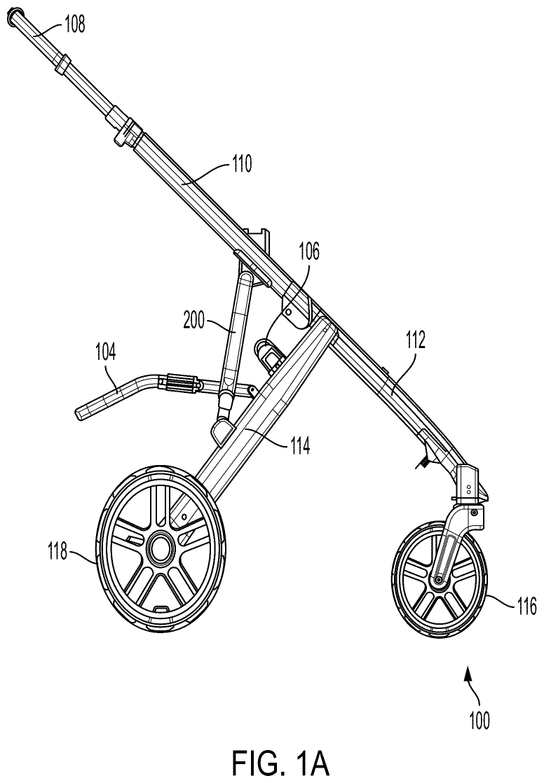

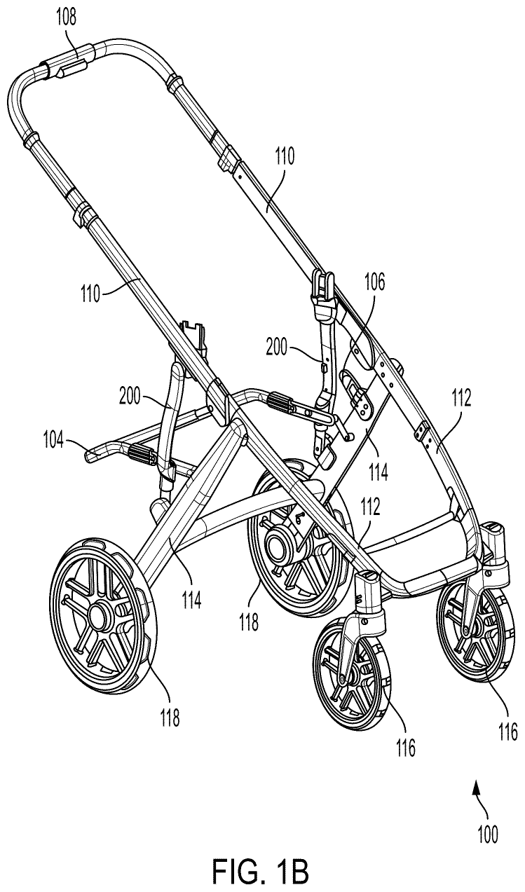

FIGS. 1A and 1B illustrate a stroller 100 according to an example. FIG. 1A illustrates stroller 100 from a profile perspective according to an example. FIG. 1B illustrates stroller 100 from an oblique perspective according to an example. The stroller 100 has a suspension system 200 that reduces the impact of irregularities in the surfaces the stroller 100 passes over. The stroller 100 also includes a lower support 104, a latch 106, a handle 108, an upper frame section 110, a lower frame section 112, a rear frame section 114, a front wheel 116, and a rear wheel 118. Stroller 100 may also have a storage position, where stroller 100 is folded into a minimized profile easy to store, and a use position, where stroller 100 is unfolded and ready to be used to transport a passenger.

Suspension system 200 is coupled at a first connection to upper frame section 110 and at a second connection to rear frame section 114. Lower support 104 is pivotably coupled to rear frame section 114. Latch 106 is pivotably coupled to rear frame section 114. Handle 108 is slidably coupled to upper frame section 110. Upper frame section 110 is coupled to handle 108 at a first connection, to lower frame section 112 at a second connection, and to suspension system 200 at a third connection. Lower frame section 112 is coupled to front wheel 116 at a first connection and to rear frame section 114 at a second connection. Rear frame section 114 is coupled to rear wheel 118 at a first connection, rear support 104 at a second connection, suspension system 200 at a third connection, latch 106 at a fourth connection, and pivotably coupled to lower frame section 112 at a fifth connection.

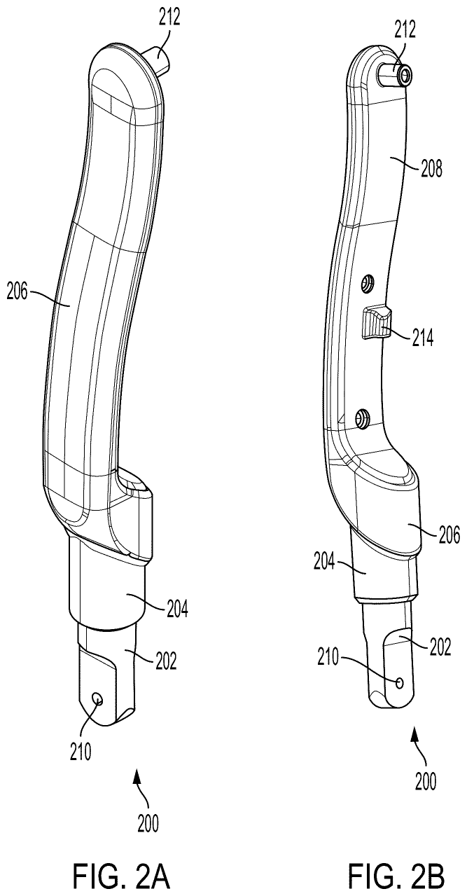

Suspension system 200 will be discussed in greater detail with respect to FIGS. 2A-6.

Lower support 104 may be pivotably connected to rear frame section 114 such that lower support 104 may be folded into a stowed position and an unstowed position. In the unstowed position, lower support 104 may support (i.e., hold in place) a stroller seat, stroller basket, or other accessory designed to be coupled to stroller 100. In the stowed position, lower support 104 may be folded up into a position that minimizes the profile of lower support 104 to make stroller 100 easier to stow.

Latch 106 has an open position and a closed position. In the open position, latch 106 will not prevent stroller 100 from being placed into the storage position. In the closed position, latch 106 may retain or help to retain stroller 100 in the storage position. Latch 106 may be configured to connect to suspension system 200 when stroller 100 is in the storage position.

Handle 108 may slide in and out of upper frame section 110 (i.e., telegraphing) and may contain a control element, such as a button, switch, level, slide, and so forth, that may control whether stroller 100 is locked into the storage or use position, or not locked into said positions.

Rear wheel 118 may be larger than front wheel 116. Front wheel 116 may be pivotably attached to lower frame section 112 and may have up to 360 degrees of freedom to rotate in at least one plane with respect to the rear wheel 118. Stroller 100 may have additional rear wheels 118 and front wheels 116. In some examples, stroller 100 has two rear wheels 118 and two front wheels 116.

Stroller 100 may include other elements as well. For example, stroller 100 may optionally include a canopy to cover the passenger or passengers from sun, rain, wind, and so forth. The components of stroller 100 may be coupled together using various fasteners, including screws, nuts, bolts, welds, rivets, adhesives, and so forth.

FIG. 2A illustrates suspension system 200 according to an example. Suspension system 200 includes a lower shroud section 202 (“lower section 202”), a sliding shroud section 204 (“sliding section 204”), a upper shroud section 206 (“upper section 206”), a capping shroud section 208 (“cap section 208”), a lower mating feature 210, a upper mating feature 212, and a latch mating feature 214.

Lower section 202 is configured to mate with rear frame section 114 via the lower mating feature 210. Lower mating feature 210 is configured to receive a pin, axle, bolt, or other connecting mechanism to pivotably couple lower section 202 to rear frame section 114. Lower section 202 is also configured to slidably couple to sliding section 204.

Upper section 206 may be coupled to cap section 208. Upper section 206 may be slidably coupled to sliding section 204. Cap section 208 may also be slidably coupled to sliding section 204. Upper section 206 may be coupled to upper mating feature 212. Upper mating feature 212 may be configured to mate with upper frame section 110 via a pin, axle, bolt or other connecting mechanism or via a receptacle configured to receive upper mating feature 212.

Cap section 208 may be coupled to latch mating feature 214. Latch mating feature 214 may be a hook or other device configured to mate with latch 106, such that when latch 106 is in the closed position it is removably but fixedly coupled to latch mating feature 214.

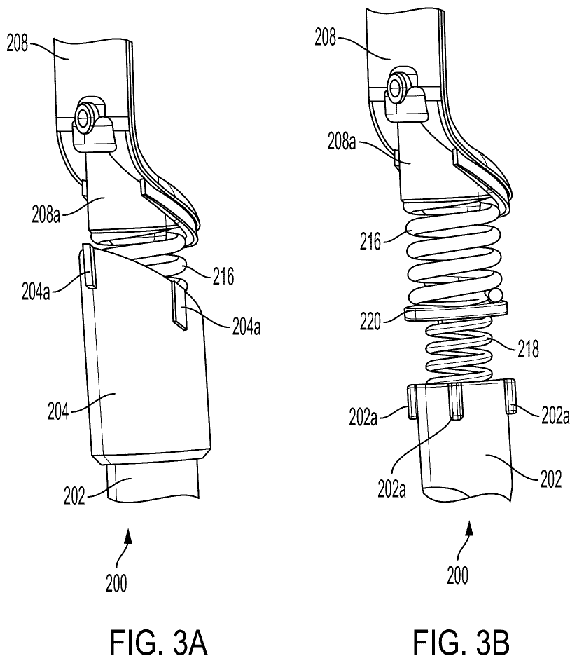

FIGS. 3A and 3B illustrate portions of the interior of suspension system 200 with various elements omitted, according to examples.

FIG. 3A shows the interior of suspension system 200 according to an example. FIG. 3A omits upper section 206 so that various interior components of suspension system 200 may be seen. The interior components include a spring retention element 208a, a first spring 216, and a second plurality of prongs 204a. FIG. 3B shows the interior of suspension system 200 according to an example. FIG. 3B omits sliding section 204 and upper section 206. Interior components include the spring retention element 208a, first spring 216, second spring 218, washer 220, and a first plurality of prongs 202a.

With reference to both FIGS. 3A and 3B, spring retention element 208a is a portion of cap section 208 and is shaped such that the overall taper of spring retention element 208a where it intersects with the rest of cap section 208 matches and is parallel to the shape and taper of sliding section 204, except that spring retention element 208a has a smaller radius. That is, the central (longitudinal) axes of both spring retention element 208a and sliding section 204 are the same or approximately the same, but the radius of sliding section 204 is greater than that of spring retention element 208a, and may provide a limit on upward motion of sliding section 204. In some examples, spring retention element 208a may have a radius greater than the outer radius of sliding section 204, and may provide a limit on downward motion of sliding section 204.

First spring 216 and second spring 218 sit within the chamber created by the shroud elements. In particular, first spring 216 sits against and may be within a lower portion of spring retention element 208a at one end, and against washer 220a at another end. Second spring 218 sits against and may be within an upper portion of lower section 202 at one end, and against washer 220 at another end. In some examples, the end of first spring 216 in contact with and/or within spring retention element 208a may be fixedly coupled (e.g., by a fastener) to spring retention element 208a. In some examples, the end of second spring 218 in contact with and/or within lower section 202 may be fixedly coupled (e.g., by a fastener) to lower section 202. One face of washer 220 contacts first spring 216, and the opposite face of washer 220 contacts second spring 218. When sliding section 204 and upper section 206 are in place, the springs and washer are entirely or substantially covered and/or contained within the shroud sections. First spring 216 and second spring 218 may be coil springs. In some examples, the spring having the lower spring coefficient may have a spring coefficient approximately 40% to 70% that of the spring having the higher spring coefficient. For example, first spring 216 may have a spring coefficient 40% to 70% that of second spring 218, or second spring 218 may have a spring coefficient 40% to 70% that of first spring 216. However, the range of spring coefficients is not exclusive. The spring coefficient of the spring with the lower coefficient may range from anything greater than 0% to 100% of the other spring's spring coefficient.

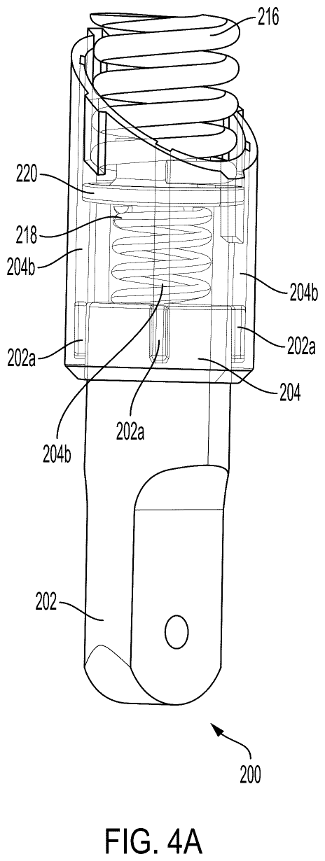

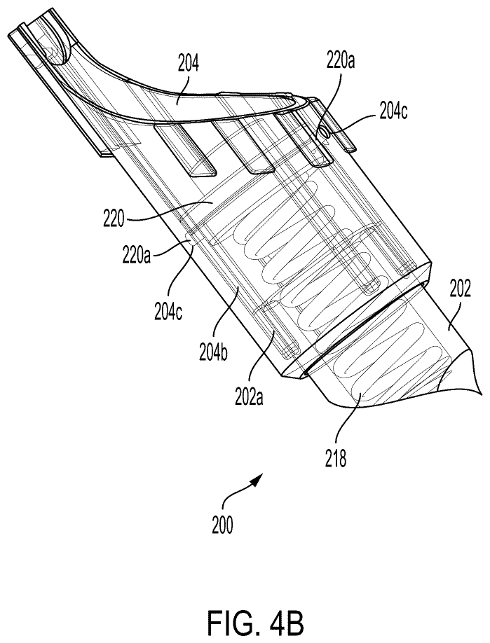

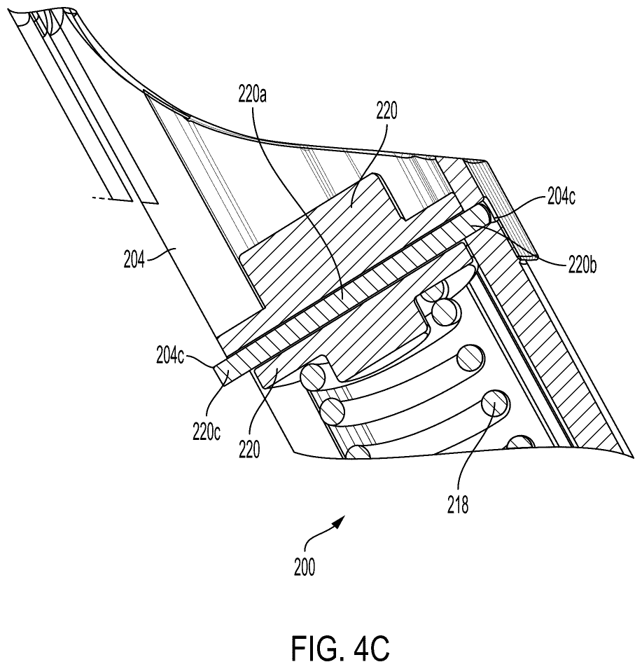

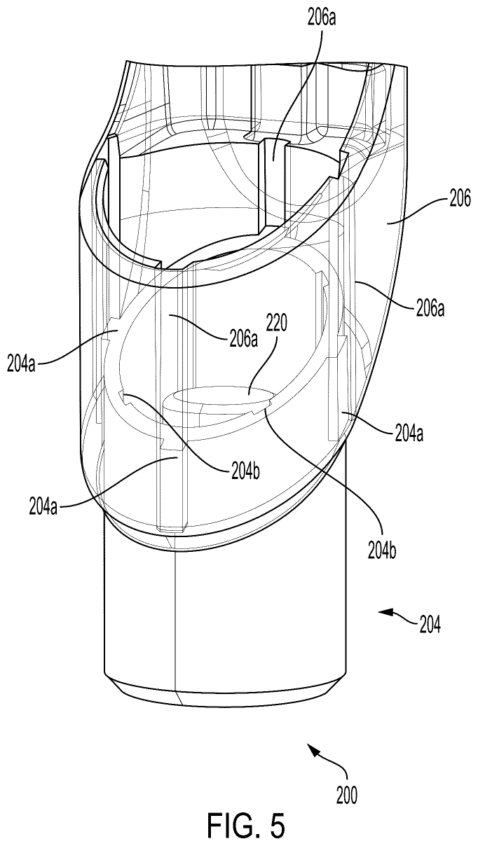

First plurality of prongs 202a may be part of lower section 202. Each prong of first plurality of prongs 202a may protrude from the exterior surface of lower section 202 by a small amount (for example, 0.5 cm, 1 cm, and so forth). Each prong of first plurality of prongs 202a may be configured to sit or rest within a corresponding channel located on an interior surface of sliding section 204. These channels (discussed below with respect to FIGS. 4 and 5) may be wide enough and deep enough to accommodate prongs of first plurality of prongs 202a, and may have a length less than or equal to the length of the portion of the interior surface of sliding section 204 to which the channel corresponds. The channels may be parallel to the longitudinal axis of the shroud sections to which they are incorporated. Thus, in some examples, when first spring 216 and/or second spring 218 are stretched (i.e., elongated relative to their respective equilibrium states), first plurality of prongs 202a may limit the motion of sliding section 204 such that a gap cannot appear between sliding section 204 and lower section 202 and/or such that sliding section 204 and lower section 202 cannot become decoupled.

Second plurality of prongs 204a may be similar to first plurality of prongs 202a in that second plurality of prongs 204a may protrude from an exterior surface of sliding section 204a by a small amount (for example, 0.5 cm, 1 cm, and so forth). Each prong of second plurality of prongs 204a may be configured to sit or rest within a corresponding channel located on an interior surface of upper section 206. These channels, (discussed below with respect to FIGS. 4 and 5) may be wide enough and deep enough to accommodate prongs of second plurality of prongs 204a, and may have a length less than or equal to the length of the portion of the interior surface of upper section 206 to which the channel corresponds. Thus, in some examples, when first spring 216 and/or second spring 218 are stretched (i.e., elongated relative to their respective equilibrium states), second plurality of prongs 204a may limit the motion of sliding section 204 relative to upper section 206 such that a gap cannot appear between sliding section 204 and upper section 206 and/or such that sliding section 204 and upper section 206 cannot become decoupled.

First spring 216 and second spring 218 may have different spring coefficients. In effect, this means that one of the springs may be easier to stretch or compress (e.g., require less energy or work to stretch and/or compress), while the other is relatively more difficult to stretch or compress. In some examples, first spring 216 is the stiffer spring (i.e., the spring with the higher spring coefficient). First spring 216 and second spring 218 do not directly contact one another. Instead, washer 220 sits between first spring 216 and second spring 218. Because, in some examples, one spring may be larger than the other (e.g., first spring 216 may have a larger inner and/or outer radius relative to second spring 218, or vice versa), washer 220 may allow the force exerted by one spring to be transmitted through washer 220 to the other spring. In other examples, washer 220 may be fixed within the shroud. That is, in some examples, washer 220 may be coupled to an inner surface of sliding section 204. In such examples, forces acting on the stroller and transmitted through the shroud (specifically, through sliding section 204) to washer 220 cause washer 220 to compress at least one of the springs. The compressed spring will then attempt to return to equilibrium (that is, a state where the spring is neither compressed nor stretched) and will exert a return force on washer 220. In some examples, washer 220 may not be fixedly coupled to sliding section 204, but may instead have limited travel within sliding section 204. In such examples, when sliding section 204 moves a predetermined amount from its equilibrium position, washer 220 may contact a prong or other internal component which applies force to washer 220 in the direction sliding section 204 is moving. This force may cause washer 220 to move as though washer 220 were fixedly coupled to sliding section 204 for a predetermined distance and through a predetermined range of motion.

Consider an example of the foregoing functions. Suppose second spring 218 has the lower spring coefficient. When stroller 100 goes over a bump, pothole, or other irregularity, the bottom-most portions of stroller 100 may move upward. This upward force may cause lower section 202 to move upward, compressing second spring 218 and may cause lower section 202 to move upward relative to sliding section 204 (or, equivalently, sliding section 204 to slide downward relative to lower section 202). To return to equilibrium, second spring 218 may stretch (that is, decompress) and exert force on washer 220. Washer 220 may transfer that force to first spring 216. Because first spring 216 has the higher spring coefficient, first spring 216 may not compress or stretch as much as second spring 218, despite experiencing a similar or equal amount of force. In this way, the deviation from equilibrium of first spring 216 may be generally less than the deviation from equilibrium of second spring 218 for any given force. As second spring 218 returns to equilibrium, sliding section 204 may slide upward relative to lower section 202 (or, equivalently, lower section 202 may be downward relative to sliding section 204). In some cases, as sliding section 204 slides upward relative to lower section 202, sliding section 204 may slide upward relative to upper section 206 and/or cap section 208. In this context, first spring 216 effectively dampens the force felt by portions of stroller 100 to which first spring 216 is attached. Likewise, both first spring 216 and second spring 218 may absorb and disperse some of the energy from the irregularity.

As previously mentioned, sliding section 204 is able to move relative to lower section 202 and upper section 206 (or, equivalently, lower section 202 and upper section 206 are able to move relative to sliding section 204). Note that cap section 208 moves with upper section 206. The movement of the other sections of the shroud relative to sliding section 204 is along the direction of the longitudinal axis of sliding section 204. As a result, the overall travel of the different sections, and thus the overall travel of spring retention element 208a, is much greater than it would be for a shroud comprising two or fewer sections slidably coupled together. At the same time, the overall shape of the suspension system 200 (that is, the overall shape of the shroud) is maintained despite the greater travel available to the sections of the shroud. As a result, the suspension system 200 can absorb more force along a longer total length of compression (relative to the longitudinal axes of the springs) before bottoming out (that is, before reaching a state of maximum compression), and can stretch to a greater extent (relative to the longitudinal axes of the springs) before reaching a state of maximum extension.

Thus, the suspension system 200 reduces the overall motion felt by a passenger of stroller 100 and reduces the magnitude of the motion experienced and/or increases the amount of time over which the motion is experienced. The motion due to the irregularities is therefore transformed from an impulse (or other sudden, relatively sharp movement) into a slower, steadier, and softer movement less likely to cause discomfort or disturb the passenger.

Spring retention element 208a may be other shapes rather than cylindrical (though it may be cylindrical as well). Spring retention element 208a may be rectangular, square, or any other shape, and may include a receptacle (e.g., hollow portion) for receiving first spring 216. The term cylindrical is not limiting and is not intended to exclusively describe the potential shapes of spring retention element 208a.

FIG. 4 illustrates a portion of suspension system 200 according to an example. In FIG. 4, sliding section 204 is shown in a wireframe view, such that interior surface elements of sliding section 204 can be seen. In particular, a first plurality of channels 204b is visible. The channels of first plurality of channels 204b extend from approximately the topmost portion of sliding section 204 to a lower portion of sliding section 204 near the lowermost extreme of sliding section 204. The channels of first plurality of channels 204b are wide enough and deep enough to accommodate the first plurality of prongs 202a, such that one prong of first plurality of prongs 202a is located within each channel of first plurality of channels 204b. The channels and prongs allow lower section 202 and sliding section 204 to slide up and down (e.g., along their lateral axes) with respect to one another.

FIG. 5 illustrates a portion of suspension system 200 according to an example. In FIG. 5, sliding section 204 is shown in a solid view and upper section 206 is shown in a wireframe view, such that various interior surface elements of upper section 206 can be seen. Upper section 206 includes a second plurality of channels 206a corresponding to second plurality of prongs 204a. Each channel of second plurality of channels 206a is large enough to accommodate the prongs of second plurality of prongs 204a. Second plurality of prongs 204a may limit the range of movement of upper section 206 relative to sliding section 204 by constraining both shroud sections 204, 206 to move within the range of motion defined by the second plurality of channels 206a. That is, the channels and prongs allow sliding section 204 and upper section 206 to slide up and down (e.g., along their lateral axes) with respect to one another. Because cap section 208 may be fixedly coupled to upper section 206, the cap section 208 may move with upper section 206 relative to sliding section 204.

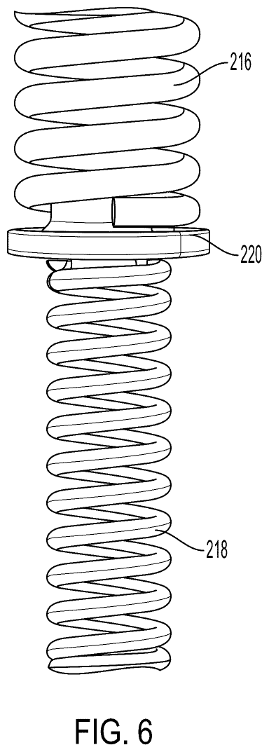

FIG. 6 illustrates springs 216, 218 and washer 220 according to an example. One spring may be longer than the other. In FIG. 6, second spring 218 is longer than first spring 216. However, first spring 216 may, in some examples, be longer than second spring 218, or the springs may be of equal length.

Washer 220 may have protrusions corresponding to the center of first spring 216 and second spring 218. That is, the protrusions may have longitudinal axes matching the longitudinal axes of first spring 216 and/or second spring 218. The protrusion corresponding to first spring 216 may have a radius less than that of the inner radius of first spring 216. The protrusion corresponding to second spring 218 may have a radius less than that of the inner radius of second spring 218. The protrusions may assist to keep the springs centered and in place with respect to washer 220. In some examples, one or more of the protrusions may be circular (i.e., circular protrusions), and in some examples one or more of the protrusions may be other shapes (e.g., triangles, rectangles, squares, and so forth). In some examples, the protrusions may be hooks or other fastening mechanisms for holding the springs in place. In other examples, the protrusions may have a larger radius than the outer radius of the spring, but may be hollow on the inside at least where the protrusions would otherwise intersect the springs. In such examples where the protrusions are located outside the outer radius of the springs, the protrusions may act like a sheath or guard that holds the springs in place from the outside.

In some examples, more than one sliding section 204 may be present. In principle, there is no limit to the number of nested sliding sections that may be used, for example, in a telescoping configuration. Likewise, additional washers and springs could be included, corresponding to the number of sliding sections present, although two springs and a single washer also works with an arbitrary number of sliding sections of the shroud.

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items.

References to “or” may be construed as inclusive so that any terms described using “or” may indicate any of a single, more than one, and all of the described terms. In addition, in the event of inconsistent usages of terms between this document and documents incorporated herein by reference, the term usage in the incorporated features is supplementary to that of this document; for irreconcilable differences, the term usage in this document controls.

Having thus described several aspects of at least one embodiment, it is to be appreciated various alterations, modifications, and improvements will readily occur to those skilled in the art. Such alterations, modifications, and improvements are intended to be part of, and within the spirit and scope of, this disclosure. Accordingly, the foregoing description and drawings are by way of example only.

What is claimed is:

1. A suspension system for a stroller, the suspension system comprising:
a shroud having a lower section, an upper section, and a middle section slidably coupled between the lower section and upper section, the middle section configured to provide a degree of travel to the lower section and upper section equal to or less than a length of the middle section;
a first spring located at least partially within the lower section;
a second spring located at least partially within the upper section; and
a washer located between the first spring and the second spring and within the middle section.

2. The suspension system of claim 1 further comprising:
a spring retention element coupled to the upper section and configured to mate with the second spring, the spring retention element having a smaller radius than the middle section.

3. The suspension system of claim 1 further comprising a cap section coupled to the spring retention element and the upper section, the cap section including a mating feature configured to mate with a locking mechanism on the stroller.

4. The suspension system of claim 1 wherein the washer is coupled to an interior surface of the middle section.

5. The suspension system of claim 1 wherein one of the upper section and the lower section has a larger radius than the middle section, and one of the upper section and lower section has a smaller radius than the middle section.

6. The suspension system of claim 1 wherein one of the first spring and second spring has a higher spring coefficient than another of the first spring and second spring.

7. The suspension system of claim 1 wherein:
the lower frame section includes one or more prongs;
the sliding frame section includes one or more channels; and
the one or more prongs are configured to slidably travel within the one or more channels.

8. The suspension system of claim 7 wherein the one or more channels are oriented along a direction parallel to a longitudinal axis of the middle section.

9. The suspension system of claim 1 wherein:
the middle section includes one or more prongs;
the upper frame section includes one or more channels; and
the one or more prongs are configured to slidably travel within the one or more channels.

10. The suspension system of claim 1 wherein:
the washer includes a first protrusion on a first face of the washer and a second protrusion on a second face of the washer, the first and second faces being on opposite sides of the washer; and
the first protrusion having a radius less than an inner radius of the first spring, and the second protrusion having a radius less than an inner radius of the second spring.

11. A stroller comprising:
a frame having at least an upper portion and a lower portion; and
a suspension system coupled between the upper portion of the frame and the lower portion of the frame, the suspension system including:
a lower section coupled to the lower portion of the frame;
an upper section coupled to the upper portion of the frame;
a sliding portion coupled between the lower section and the upper section, the middle section configured to provide a degree of travel to the lower section and upper section equal to or less than a length of the middle section;
a first spring at least partially within the lower section;
a second spring at least partially within the upper section; and
a washer between the first spring and the second spring and within the middle section.

12. The stroller of claim 11 wherein the suspension system further comprises:
a spring retention element coupled to the upper section and configured to mate with the second spring, the spring retention element having a smaller radius than the middle section.

13. The stroller of claim 11 further comprising a first mating feature coupled to the frame; and
wherein the suspension system further includes a second mating feature coupled to the upper section and configured to mate with the first mating feature.

14. The stroller of claim 11 wherein the stroller is configurable into a stowable position from a use position and a use position from a stowable position.

15. The stroller of claim 11 wherein the suspension system further comprises:
one or more prongs coupled to the lower frame section;
one or more channels incorporated into the sliding frame section; and
the one or more prongs are configured to slidably travel within the one or more channels.

16. The stroller of claim 11 wherein the suspension system further comprises:
one or more prongs coupled to the sliding frame section;
one or more channels incorporated into the upper frame section; and
the one or more prongs are configured to slidably travel within the one or more channels.

17. The stroller of claim 11 wherein the washer further comprises:
a first protrusion on a first face of the washer and a second protrusion on a second face of the washer, the first and second faces being on opposite sides of the washer; and
the first protrusion having a radius less than an inner radius of the first spring, and the second protrusion having a radius less than an inner radius of the second spring.

18. The stroller of claim 11 wherein one spring of the first spring and second spring has a higher spring coefficient than another spring of the first spring and second spring.

19. A suspension system for a stroller, the suspension system comprising:
an upper section;
a lower section; and
a middle section, the middle section being configured to provide a range of travel between the upper section and lower section in a direction of a longitudinal axis of the middle section, the range of travel being less than or equal to a length of the middle section along the longitudinal axis, the middle section, upper section, and lower section being biased by a biasing mechanism into an equilibrium position when the stroller is at rest.

20. The suspension system of claim 19 wherein the biasing mechanism includes:
a first spring having a first spring coefficient located at least partially in the lower section;
a second spring having a second spring coefficient different than the first spring coefficient and located at least partially in the upper section; and
a washer located within the middle section and having a first protrusion on a first face of the washer and a second protrusion on a second face of the washer, the first and second faces being on opposite sides of the washer, the first protrusion having a radius less than an inner radius of the first spring, and the second protrusion having a radius less than an inner radius of the second spring.
